(19) United States
(12) Patent Application Publication
(10) Pub. No.: US 2015/0302951 A1
(43) Pub. Date: Oct. 22, 2015

(54) TRANSPARENT CONDUCTIVE FILM HAVING BENDING RESISTANCE, AND METHOD FOR MANUFACTURING SAME

(71) Applicant: LG Hausys, Ltd., Seoul (KR)

(72) Inventors: Keun JUNG, Gwacheon-si, Gyeonggi-do (KR); In Sook KIM, Daejeon (KR); Jung CHO, Seoul (KR); Kyung Taek KIM, Bucheon-si, Gyeonggi-do (KR); Dong Eung KIM, Gunpo-si, Gyeonggi-do (KR); Hui Jun SIM, Seoul (KR); Sung Hyun CHOI, Anyang-si, Gyeonggi-do (KR)

(21) Appl. No.: 14/406,304

(22) PCT Filed: Dec. 21, 2012
(86) PCT No.: PCT/KR2012/011231

§ 371 Date: Dec. 8, 2014

(30) Foreign Application Priority Data
Jun. 18, 2012 (KR) 10-2012-0064672

(51) Int. Cl. H01B 5/14; G06F 3/041

(52) U.S. Cl. CPC H01B 5/14; G06F 3/0412; G06F 2203/04102

(57) ABSTRACT

Provided is a transparent conductive film which includes: a transparent base material; hard coating layers formed on either surface of the transparent base material; and at least one transparent conductive layer formed on the hard coating layer. Also provided is a method for manufacturing the transparent conductive film, which includes: a step of forming hard coating layers on either surface of the transparent base material; and a step of forming the transparent conductive layer on the hard coating layer using a sputtering method.

### TECHNICAL FIELD

The present invention relates to a transparent conductive film having bending resistance, and more particularly, to a transparent conductive film including a hard coating layer having an optimum thickness for securing bending resistance and a method for manufacturing the transparent conductive film.

### BACKGROUND ART

Today, transparent conductive films used in the touchscreen panel industry are mostly manufactured in a capacitive manner, and electrical and optical characteristics of the transparent conductive films are primarily taken into consideration. All the components, including transparent conductive films, for future developments in flexible display need to have durability for bending resistance.

However, detailed studies on structures of a base film and a hard coating layer used for a transparent conductive film to enhance bending resistance have not been carried out. Japanese Patent Laid-open Publication No. 1998-114159 discloses a structure of a transparent conductive film including a base film and a hard coating layer. However, this structure is proposed just for securing certain hardness and durability of the transparent conductive film, and fails to secure bending resistance. This structure still has a problem of a typical transparent conductive film that suffers from large variation in bending resistance.

### DISCLOSURE

### Technical Problem

It is an aspect of the present invention to provide a transparent conductive film having improved bending resistance which can be used for flexible display.

### Technical Solution

In accordance with one aspect of the present invention, a transparent conductive film includes: a transparent base film; a hard coating layer formed on both surfaces of the transparent base film; and a transparent conductive layer formed on the hard coating layer.

The hard coating layer may have a thickness of about 2 μm to about 4 μm.

The hard coating layer may have a thickness of about 3 μm to about 4 μm.

The hard coating layer may have hardness of about 1H to about 2H.

The transparent conductive film may further include at least one undercoating layer formed on a surface of the transparent conductive layer facing the transparent base film.

The undercoating layer may include silicon oxide.

The transparent conductive film may have a limit radius of curvature of about 1 cm to about 3 cm.

In accordance with another aspect of the present invention, a method for manufacturing a transparent conductive film comprises: forming a hard coating layer on both surfaces of a transparent base film; and forming a transparent conductive layer on the hard coating layer by a sputtering process.

The method may further include forming at least one undercoating layer on a surface of the transparent conductive layer facing the transparent base film.

### Advantageous Effects

The transparent conductive film according to the present invention has superior bending resistance and thus can be used as a transparent electrode element for flexible displays.

Further, a resistance change rate of the transparent conductive film can be reduced to 10% or less.

### DESCRIPTION OF DRAWINGS

FIG. 1 is a cross-sectional view schematically illustrating a constitution of a transparent conductive film.

FIG. 2 is a cross-sectional view schematically illustrating a constitution of a transparent conductive film including an undercoating layer.

FIG. 3 is a cross-sectional view schematically illustrating a radius of curvature of a transparent conductive film.

FIG. 4 is a cross-sectional view illustrating (a) positive bending and (b) negative bending of a transparent conductive film.

FIG. 5 is a graph illustrating experiment results of a resistance change rate according to the number of bending.

### BEST MODE

Hereinafter, exemplary embodiments of the present invention will be described in detail with reference to the accompanying drawings so that the present invention will be easily understood and realized by those skilled in the art. It should be understood that the present invention may be embodied in many different forms and is not limited to the embodiments set forth herein.

In the drawings, portions irrelevant to the description will be omitted for clarity, and like components will be denoted by like reference numerals throughout the specification.

In the drawings, the thicknesses of layers and regions are exaggerated or omitted for convenience of description. It will be understood that when an element such as a layer, film, region or substrate is referred to as being placed “on” another element, it can be directly placed on the other element, or an intervening layer(s) may also be present. On the other hand, when an element is referred to as being directly placed “on” another element, an intervening layer(s) is not present.

Exemplary embodiments of the present invention will now be described in detail.

Transparent Conductive Film

A transparent conductive film according to one embodiment of the present invention includes a transparent base film, a hard coating layer formed on both surfaces of the transparent base film, and at least one transparent conductive layer formed on the hard coating layer.

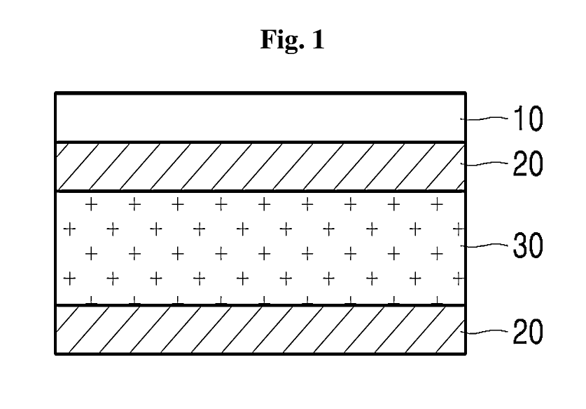

Referring to FIG. 1, a transparent conductive film 100 includes a transparent conductive layer 10, a hard coating layer 20, a transparent base film 30, and a hard coating layer 20, which are arranged in order from the top.

A hard coating layer coated on a base film to manufacture a typical transparent conductive film has a thickness in the range of about 1 μm to about 30 μm. However, the thickness of the hard coating layer of the typical transparent conductive film is merely determined to adjust hardness of the hard coating layer without consideration of bending resistance of the transparent conductive film.

According to one embodiment of the invention, a thickness of the hard coating layer is optimized so as to apply the transparent conductive film having bending resistance to flexible displays. Adjustment of thickness of the hard coating layers formed on both surfaces of the transparent base film, i.e., a seed layer deposited on the transparent conductive layer, makes it possible to adjust stress applied to the transparent conductive layer under typical bending conditions in flexible displays. Particularly, two hard coating layers 20 may be formed to have the same thickness.

More particularly, stress applied to the transparent conductive layer can cause resistance increase, and can also affect a touch panel module used in a flexible display. Increase in resistance due to stress acting on the transparent conductive layer can be reduced by adjusting the thickness of the hard coating layer.

Specifically, a curling phenomenon can be prevented by forming the hard coating layers on both surfaces of the transparent base film to have the same thickness.

The transparent base film 30 may be formed of polyethylene terephthalate (PET), polyether sulfone (PES), polycarbonate (PC), polyimide (PI) or the like. In the case where the transparent base film 30 is formed of PET, the PET film has a thickness of about 20 μm to about 100 μm, preferably about 20 μm to about 100 μm. If the thickness of the transparent base film 30 is less than about 20 μm, mechanical strength of the transparent base film 30 can be insufficient, and it can be difficult to consecutively form the hard coating layer 20 and the transparent conductive layer 10 on a roll of the transparent base film 30. If the thickness of the transparent base film 30 exceeds about 100 μm, it can be difficult to improve anti-abrasive characteristics of the transparent conductive layer 10 or touch characteristics for a touch panel.

The surface of the transparent base film 30 may be previously subjected to treatment such as sputtering treatment, corona discharge treatment, flame treatment, ultraviolet irradiation, electron beam irradiation, conversion treatment, etching treatment such as oxidation, or undercoating treatment so as to improve adhesion of the hard coating layer 20 to the transparent base film 30. Alternatively, before forming the hard coating layer 20, the transparent base film 30 may be subjected to dust removal or cleaning by washing with a solvent or ultrasonic cleaning, as needed.

The material of the transparent conductive layer 10 is not particularly limited, and may include a metal oxide of at least one metal selected from the group consisting of indium, tin, zinc, gallium, antimony, titanium, silicon, zirconium, magnesium, aluminum, gold, silver, copper, palladium, tungsten, and combinations thereof. The metal oxide, if necessary, may additionally include metal atoms selected from the aforementioned group. For example, indium oxide containing tin oxide or tin oxide containing antimony may be used.

The thickness of the transparent conductive layer 10 is not particularly limited, however, the thickness is preferably about 10 nm or more. Because the excessively large thickness of the transparent conductive layer 10 causes deterioration of transparency, the thickness of the transparent conductive layer 10 is particularly in the range of about 15 nm to about 35 nm, and more particularly about 20 nm to about 30 nm. If the thickness is less than about 15 nm, surface electrical resistance is increased and continuous film formation becomes difficult. If the thickness exceeds about 35 nm, transparency is deteriorated.

The hard coating layer 20 constituting the transparent conductive film may include a photo-curable resin composition and a cross-linking agent. The photo-curable resin composition is not particularly limited so long as the resin composition is cross-linkable by typical light irradiation. Such a phot-curable resin composition may include a monomer of a compound containing at least one ethylenically unsaturated double-bond, a prepolymer, an oligomer such as dimer and trimer, mixtures thereof, and copolymers thereof.

The kind of cross-linking agent is not particularly limited, and may include a typical cross-linking agent, such as an isocyanate compound, an epoxy compound, an aziridine compound, and a metal chelating agent.

The hard coating layer 20 may be formed to a thickness of about 2 μm to about 4 μm, by which a resistance change rate of the transparent conductive film after a bending test can be reduced to 10% or less. When the hard coating layer 20 having a thickness in the above range is subjected to bending deformation, stress applied to the transparent conductive film can be reduced. Particularly, in order to minimize stress applied to the transparent conductive film in bending deformation, the thickness of the hard coating layer 20 may be set in the range of about 3 μm to about 4 μm.

The hard coating layer 20 may have hardness of about 1 H to about 2 H. The hard coating layer 20 serves to secure bending resistance by being disposed on both surfaces of the transparent base film 30 and adjusted in thickness. In addition, since the hard coating layer 20 also serves to supplement hardness of the transparent base film 30 and to impart contamination resistance properties, it is necessary for the hard coating layer 20 to have hardness more than a certain level.

In other words, when the hardness of the hard coating layer 20 is maintained in the above range, touch characteristics for a flexible touch panel can be improved.

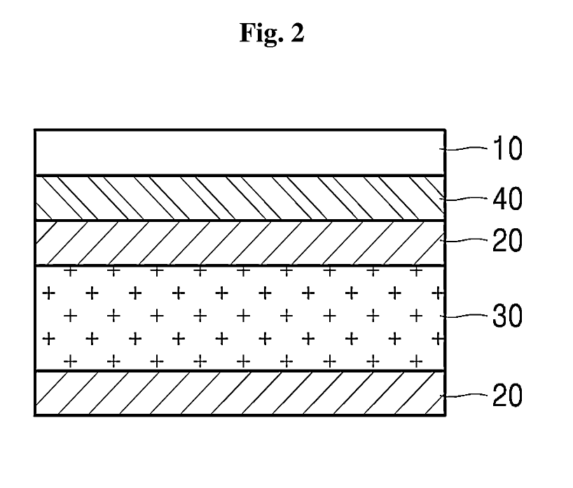

Referring to FIG. 2, according to another embodiment of the invention, a transparent conductive film 100 includes a transparent conductive layer 10, an undercoating layer 40, a hard coating layer 20, a transparent base film 30, and a hard coating layer 20, which are disposed in order from the top. That is, the transparent conductive film may further include at least one undercoating layer formed on a surface of the transparent conductive layer facing the transparent base film.

The undercoating layer 40 serves to improve insulation properties and permeability between the transparent base film 30 and the transparent conductive layer 10. Particularly, at least one undercoating layer may be formed on a surface of the transparent conductive layer 10 facing the transparent base film 30. The undercoating layer 40 may be formed of a material having an index of refraction of 1.0 to 2.0, preferably silicon oxide (SiO₂) having an index of refraction of about 1.4.

The undercoating layer 120 may be formed to a thickness of about 10 nm to about 100 nm. If the thickness of the undercoating layer 120 exceeds about 100 nm, film stress can be increased and thus cracking can occur, thereby causing deterioration in optical properties. If the thickness is less than about 10 nm, permeability and visibility of the film can be degraded.

The transparent conductive film may have a limit radius of curvature of about 1 cm to about 3 cm. The radius of curvature refers to a radius of a circle, the curvature of which is equal to that of a curve at a given point. A large radius of curvature means a low curvature and a small radius of curvature means a high curvature.

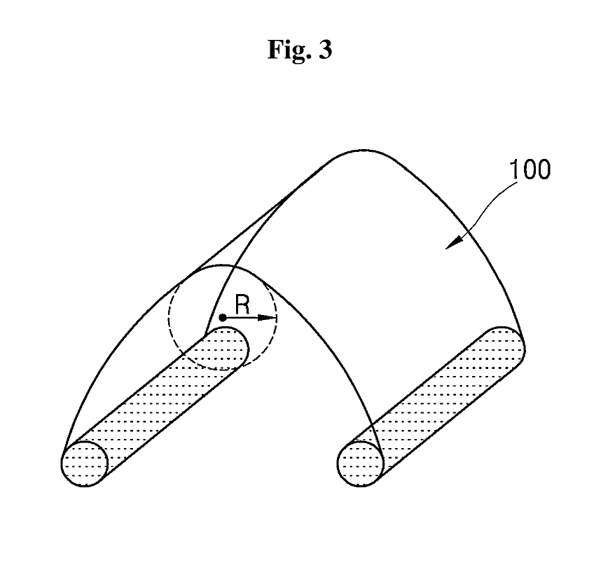

In other words, the limit radius of curvature refers to a radius of curvature when the transparent conductive film has a maximum bending degree. FIG. 3 is a cross-sectional view schematically illustrating the radius of curvature of the transparent conductive film.

The limit radius of curvature of the transparent conductive film may be set in the range of about 1 cm to about 3 cm. It is desirable to maintain the limit radius of curvature in the above range, since there is no limitation in bending deformation of elements used for a flexible touch panel. More preferably, the limit radius of curvature may be set in the range of about 1 cm to about 1.2 cm, by which there is no limitation in bending when using a flexible touch panel.

Method for Manufacturing Transparent Conductive Film

According to one embodiment of the invention, a method for manufacturing the transparent conductive film includes forming a hard coating layer on both surfaces of a transparent base film, and forming a transparent conductive layer on the hard coating layer by a sputtering process.

In the process of forming the hard coating layer on both surfaces of the transparent base film, the hard coating layer may be formed by a common coating method such as bar coating, blade coating, spin coating, gravure coating or spray coating.

In the process of forming the transparent conductive layer on the hard coating layer, the method of forming the transparent conductive layer is not particularly limited, and commonly known methods may be used. For example, a vacuum deposition method, a sputtering method or an ion plating method may be used. An appropriate method may be used according to the required thickness of the transparent conductive layer.

In addition, after forming the transparent conductive layer, if necessary, the transparent conductive layer may be crystallized by an annealing process at a temperature of about 100° C. to about 150° C. Accordingly, the transparent base film may have heat resistance against temperatures as high as about 100° C., more particularly about 150° C.

According to another embodiment of the present invention, a method for manufacturing the transparent conductive film may further include forming at least one undercoating layer on a surface of the transparent conductive layer facing the transparent base film. The undercoating layer is an inorganic oxide layer, and may be formed by various methods such as RF magnetron sputtering, ion beam deposition and DC magnetron sputtering.

Next, the present invention will be described in more detail with reference to some examples. It should be understood that these examples are provided for illustration only and are not to be in any way construed as limiting the present invention.

### EXAMPLES AND COMPARATIVE EXAMPLES

### Example 1

As a material for forming the hard coating layer, a toluene solution was prepared in such a manner that 100 parts by weight of acrylic urethane resin (Unidic 17-806 produced by Dainippon Ink & Chemicals, Inc.) and 5 parts by weight of hydroxycyclohexyl phenyl ketone (Irgacure 184 produced by Chiba Specialty Chemicals, Inc.) as a photopolymerization initiator were mixed and diluted to a concentration of 30 wt %.

The material for forming the hard coating layer was coated on both surfaces of the transparent film which was formed of a 125 μm thick PET film, and was dried at 100° C. for 3 minutes. The coated material was subsequently subjected to ultraviolet irradiation using two ozone-type high pressure mercury lamps (energy density 80 W/cm², 15 cm concentrating type), thereby preparing a hard coating layer.

Next, an ITO film (light refractive index 2.00) having a thickness of 22 nm was formed on a surface of the hard coating layer by reactive sputtering using a sintered material composed of 97 wt % of indium oxide and 3 wt % of tin oxide in an atmosphere of 98% argon gas and 2% oxygen gas at a pressure of 0.4 Pa, thereby preparing a transparent conductive film.

### Examples 2 to 4

Transparent conductive films was manufactured in the same manner as in Example 1 except that hard coating layers formed on upper and lower sides of the PET film had a thickness of 2.5 μm, 3.1 μm, 5.3 μm and 7.2 μm, respectively.

### Comparative Example 1

A transparent conductive film was manufactured in the same manner as in Example 1 except that a hard coating layer formed on an upper side of the PET film had a thickness of 4 μm and a hard coating layer formed on a lower side of the PET film had a thickness of 2 μm.

### Comparative Example 2

A transparent conductive film was manufactured in the same manner as in Example 1 except that a hard coating layer formed on an upper side of the PET film had a thickness of 2 μm and a hard coating layer formed on a lower side of the PET film had a thickness of 4 μm.

TABLE 1

| | Thickness of | Hardness of | | | Thickness of | Hardness of |
|---|---|---|---|---|---|---|
| | hard coating | hard coating | | | hard coating | hard coating |
| | layer (μm) | layer (H) | | | layer (μm) | layer (H) |
| Example | 2.5 | 2 | Comparative | Upper side | 4 | 2 |
| 1 | | | Example 1 | of base film | | |
| Example | 3.1 | 1 | | Lower side | 2 | 1 |
| 2 | | | | of base film | | |
| Example | 5.3 | 2 | Comparative | Upper side | 2 | 1 |
| 3 | | | Example 2 | of base Film | | |
| Example | 7.2 | 1 | | Lower side | 4 | 2 |
| 4 | | | | of base film | | |

### Experimental Example

### Bending Resistance of Transparent Conductive Film

In order to determine bending resistance of the transparent conductive films of the examples and the comparative examples, a radius of curvature (cm), a resistance change rate (%) and a restoration rate after bending (%) were measured.

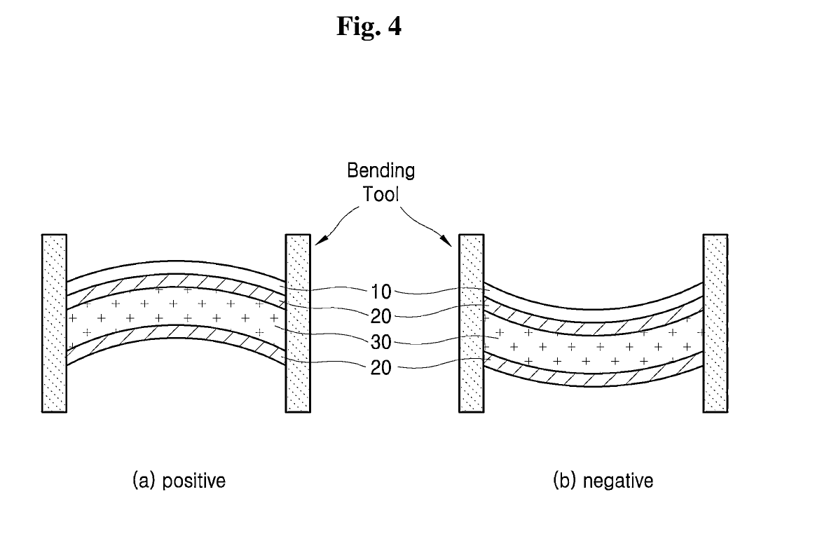

The radius of curvature, which refers to a radius of a circle including a curved portion formed when applying bending force to the transparent conductive film, was measured by applying bending force to the transparent conductive film using a bending tool (Touch Screen Panel Reliability Inspection System, Vitron Inc.). FIG. 4 is a cross-sectional view illustrating (a) positive bending and (b) negative bending of the transparent conductive film. Experiment was carried out under the condition of positive bending.

The resistance change rate (%) was calculated from formula: (resistance value after bending test/initial resistance value before bending test)×100. The resistance change rates of the transparent conductive films of the examples and the comparative examples were measured after bending tests (50,000 times).

The restoration rate after bending (%) was calculated from formula: (radius of curvature after restoration−radius of curvature after bending)/(initial radius of curvature−radius of curvature after bending)×100. The restoration rates after bending of the transparent conductive films of the examples and the comparative examples were measured after bending tests (50,000 times). The restoration rate refers to a restoration ability of a material against deformation by pressure, load, bending or the like.

TABLE 2

| | Radius of | Resistance change | Restoration rate after |
|---|---|---|---|
| | Curvature (cm) | rate (%) | bending (%) |
| Example 1 | 1.1 | 9 | 90 |
| Example 2 | 1 | 8.5 | 95 |
| Example 3 | 1.2 | 10.5 | 85 |
| Example 4 | 1.2 | 11.5 | 85 |
| Comparative | 0.8 | 15 | 60 |
| Example 1 | | | |
| Comparative | 0.5 | 20 | 65 |
| Example 2 | | | |

The measured radius of curvature, resistance change rate and restoration rate after bending of the transparent conductive films of the examples and the comparative examples are shown in Table 2. In general, it can be expected that, when the thickness of the hard coating layer having certain hardness is relatively small, stress to be exerted on the transparent conductive film is reduced and thus resistance change due to bending will be small. However, as can be seen from the above results, stress exerted on the transparent conductive film is minimized when the thickness of the hard coating layer is maintained at an optimum level, and the transparent conductive film can cope with bending deformation.

More particularly, the radius of curvature measured in Examples 1 to 4, in which the thicknesses of the hard coating layers formed on both surfaces of the transparent film were the same, is greater than the radius of curvature measured in Comparative Examples 1 and 2 in which the thicknesses of the hard coating layers formed on both surfaces of the transparent film were different. Although the transparent conductive films of Examples 1 to 4 were subjected to greater bending deformation as known from the above results of the radius of curvature, the transparent conductive film had a higher restoration rate after bending. As a result, it could be seen that the transparent conductive films had resilience above a certain level. Accordingly, it can be understood that the thickness of the hard coating layer is the most important variable in securing bending resistance.

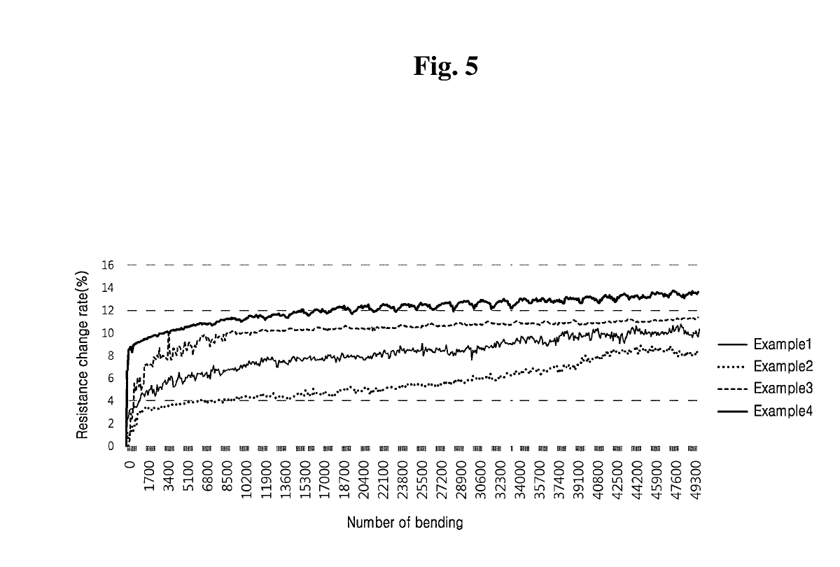

FIG. 5 shows experiment results of a resistance change rate according to the number of bending in Examples 1 to 4. The resistance change rate measured in Examples 3 and 4, in which the thickness of the hard coating layer was in the range of 4 μm to 8 μm, was not high, i.e. about 10%, and the resistance change rate measured in examples 1 and 2 was below 10%. Especially, Example 2 in which the thickness of the hard coating layer was in the range of 3 μm to 4 μm was most preferable to reduce the resistance change rate.

1. A transparent conductive film comprising:
a transparent base film;
a hard coating layer formed on both surfaces of the transparent base film; and
at least one transparent conductive layer formed on the hard coating layer.

2. The transparent conductive film according to claim 1, wherein the hard coating layer has a thickness of 2 μm to 4 μm.

3. The transparent conductive film according to claim 1, wherein the hard coating layer has a thickness of 3 μm to 4 μm.

4. The transparent conductive film according to claim 1, wherein the hard coating layer has hardness of 1 H to 2 H.

5. The transparent conductive film according to claim 1, further comprising:
at least one undercoating layer formed on a surface of the transparent conductive layer facing the transparent base film.

6. The transparent conductive film according to claim 5, wherein the undercoating layer comprises silicon oxide.

7. The transparent conductive film according to claim 1, wherein the transparent conductive film has a limit radius of curvature of 1 cm to 3 cm.
